(19) United States
(12) Patent Application Publication
(10) Pub. No.: US 2009/0027794 A1
(43) Pub. Date: Jan. 29, 2009

(54) LIGHT TUNNEL AND PROJECTOR ILLUMINATION SYSTEM HAVING SAME

(75) Inventor: MING-TE LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/959,167

(22) Filed: Dec. 18, 2007

(30) Foreign Application Priority Data
Jul. 27, 2007 (CN) 200710201190.3

(51) Int. Cl. G02B 27/00

(52) U.S. Cl. 359/894

(57) ABSTRACT

A projector light tunnel comprising an elongated transparent solid body having a light incident surface for facing toward a light source, a light emitting surface at an opposite side of the elongated transparent solid body to the light incident surface, for uniformly standardizing intensity distribution of light emitted from the light source, the light incident surface being configured as a curved surface.

### TECHNICAL FIELD

The present invention relates to a light tunnel and a projection apparatus with the same. And, particularly, to a light tunnel and a projection apparatus which improve the light intensity on the center area of the projector light tunnel and the light combination efficiency.

### BACKGROUND

Conventionally, a projection apparatus includes a light tunnel to convert a point light source generated by a lamp into a surface light source. The light generated by the lamp passes into the projector light tunnel and is reflected many time on an inner wall of the projector light tunnel, then the light is emitted from the projector light tunnel with uniform luminance and desired shape. FIG. 6 illustrating a typical optical system of a projection apparatus includes a light source 100, a solid light tunnel 120, and a light filter 130. The light source 100 has an arc lamp 101 and an elliptical reflective mirror 102. The elliptical reflective mirror 102 defines a near focal point F1 and a distant focal point F2. The arc lamp 101 is positioned at the near focal point F1 and an end of the projector light tunnel 120 is positioned at the distant focal point F2.

Accordingly, light coming from the arc lamp 101 located at the near focal point F1 of the elliptical reflective mirror 102 is focused at the distant focal point F2. The light goes directly into the projector light tunnel 120 as a point light source and is emitted from the light 120 as a surface light source with uniform luminance after multiple internal reflections in the projector light tunnel 120. The light emitted from the projector light tunnel 120 is projected through the light filter 130 to become red, green, and blue (RGB) components, then the RGB components are reflected by a digital micro-mirror device (DMD) controlled by a central processing unite (CPU) to form an image on a screen.

Generally, the arc lamp 101 of the light source 100 has two electrodes spaced from each other for generating light between the electrodes by arc discharge. The light is reflected by the elliptical reflective mirror 102 of the light source 100 and focused at the distant focal point of the elliptical reflective mirror 102. However, the electrodes of the arc lamp 101 are located in the light path, which blocks passage of some of the reflected light, as a result luminance at the center of the light emitted from the projector light tunnel 120 is lower than other areas. Additionally, some of the light is lost due to inadequate reflection angle within the tunnel.

Therefore, a light tunnel and a projection apparatus with the same which can increase the luminance in the center area of emitting light and improve the light utilization factor are desired.

### SUMMARY

In one aspect, a projector light tunnel is provided. The projector light tunnel comprising an elongated transparent solid body having a light incident surface for facing toward a light source, a light emitting surface at an opposite side of the elongated transparent solid body to the light incident surface, for uniformly standardizing intensity distribution of light emitted from the light source, the light incident surface being configured as a curved surface.

Those and other advantages and novel features will be more readily apparent from the following detailed description set forth below taken in conjunction with the accompanying drawings.

### BRIEF DESCRIPTION OF THE DRAWINGS

FIG. 1 is a perspective view of a light tunnel, according to a first preferred embodiment.

FIG. 2 is a schematic drawing showing the operation of an illumination system having the projector light tunnel of FIG. 1.

FIG. 3 is a graph of luminance of the light emitted from the projector light tunnel of FIG. 1;

FIG. 4 is a perspective view of a light tunnel, according to a second preferred embodiment;

FIG. 5 is a schematic drawing showing operation of an illumination system having the projector light tunnel of FIG. 4;

FIG. 6 is a schematic, plan view of an illumination system of a projection apparatus, according to the related art;

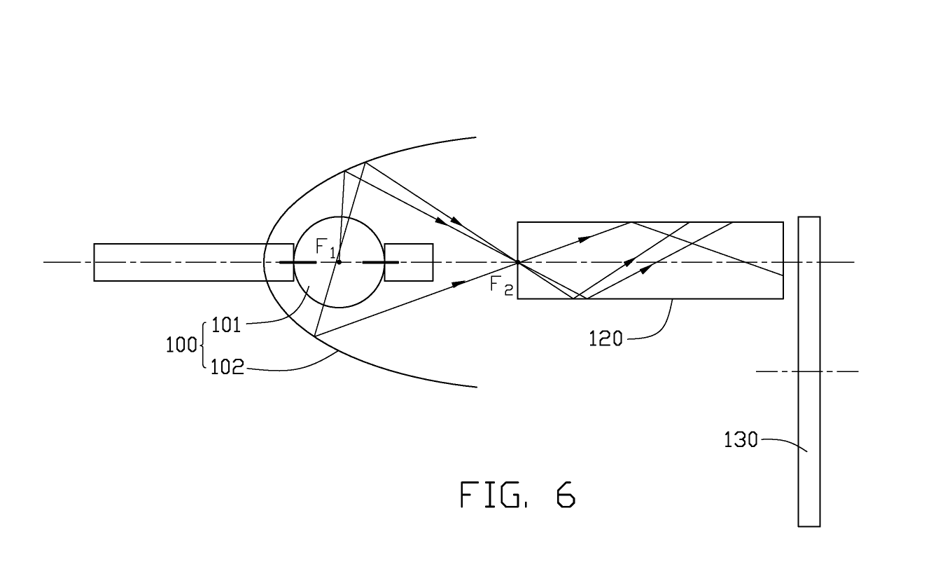

FIG. 7 is a graph of luminance of the illumination system of the FIG. 6.

### DETAILED DESCRIPTION OF THE PREFERRED EMBODIMENTS

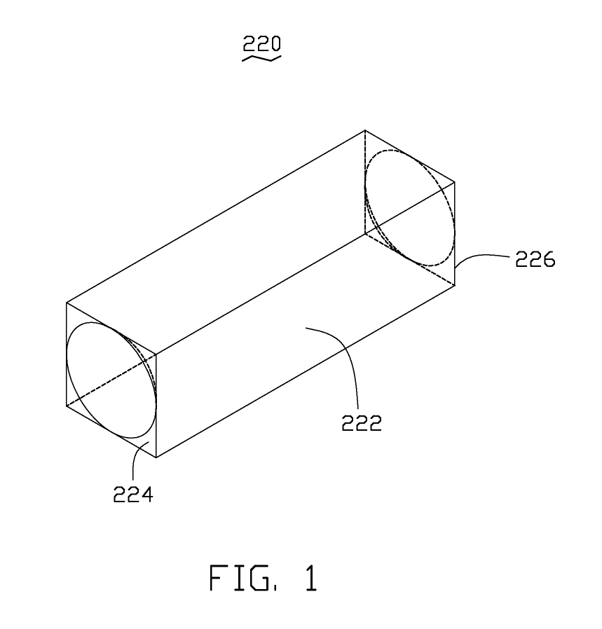

Referring to FIG. 1, a projector light tunnel 220, according to a first preferred embodiment, is an elongated transparent solid body, and includes a sidewall 222, a concave light incident surface 224 for facing toward a light source, and an light emitting surface 226 at an opposite side of the elongated transparent solid body to the light incident surface. The light radiated from a light source enters into the projector light tunnel 220 through the light incident surface 224 and is reflected many times by the sidewall 222, finally emitting as an uniform light from the light emitting surface 226 of the projector light tunnel 220.

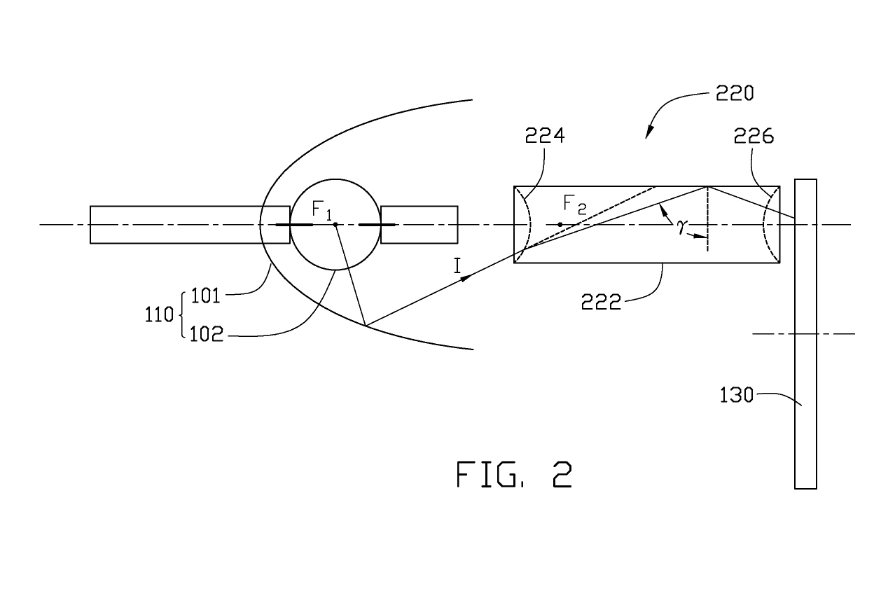

FIG. 2 is an illumination system of a projection apparatus equipped with the projector light tunnel 220. The illumination system includes a light source 100, the projector light tunnel 220, and a filter 130. The light source 100 has an arc lamp 101 and an elliptical reflective mirror 102. The elliptical reflective mirror 102 defines a near focal point F1 and a distant focal point F2.

The projector light tunnel 220 is positioned on the front of the arc lamp 101 and a center point of the light incident surface 224 is located between the near focal point F1 and the distant focal point F2 of the arc lamp 101. The arc lamp 102 radiates light l that is reflected by the elliptical reflective mirror 102 to the projector light tunnel 220. Meanwhile, the angle formed between light l and a center axis of the projector light tunnel 220 becomes small when light l enters into the projector light tunnel 220 via penetrating the concave light incident surface 224 which can change the traveling direction of light l. Accordingly, the incident angle γ of light l entering the projector light tunnel 220 becomes greater. Therefore the projector light tunnel 220 can receive more effective light than the conventional light tunnel 120, because of the concave light incident surface 224 changing the light traveling direction when it passes into the tunnel 220.

The brightness of the center area of light emitted from the projector light tunnel 220 is increased, because the distance light travels between reflections from the sidewall 222 will be increased with the increasing of the incident angle and as a result there is more light at the center axis of the projector light tunnel 220.

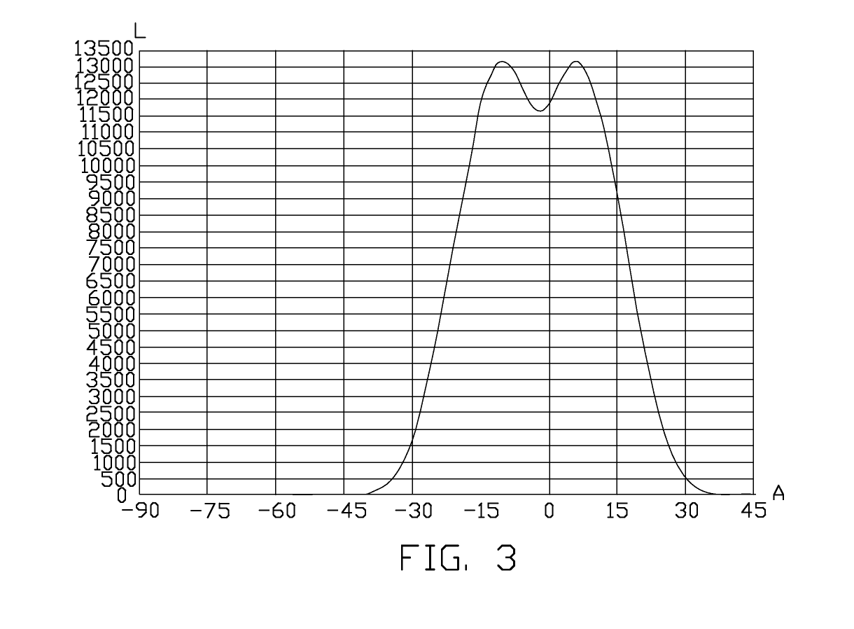

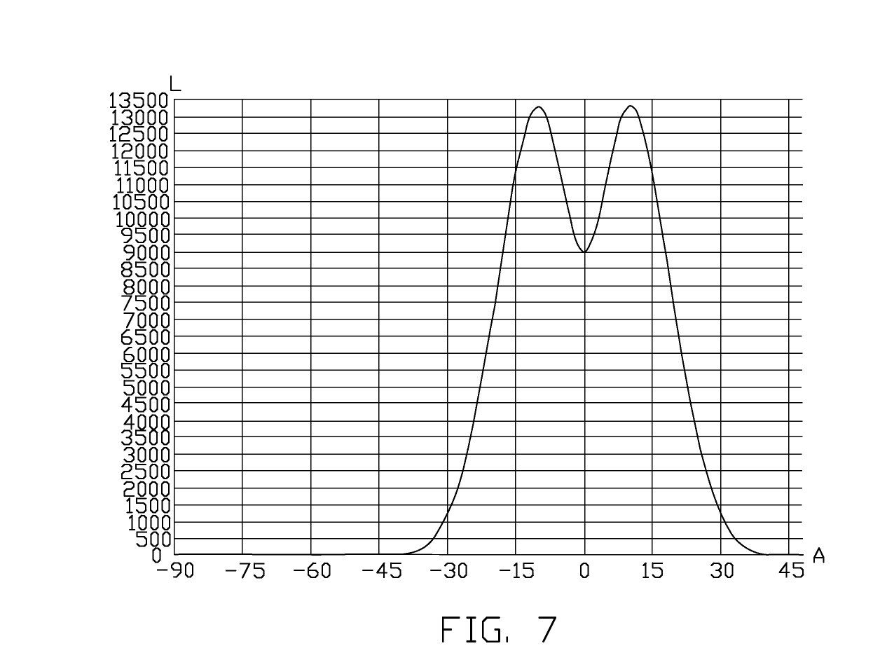

FIG. 3 shows of the projector light tunnel 220, wherein the abscissa indicates the angle formed between the light emitted from the projector light tunnel 220 and the center axis of the projector light tunnel 220, and the ordinate indicates the luminance of the light emitted from the projector light tunnel 220. It is obvious that the brightness on center area of the light emitted from the projector light tunnel 220 is higher than in the conventional light tunnel as shown in FIG. 7.

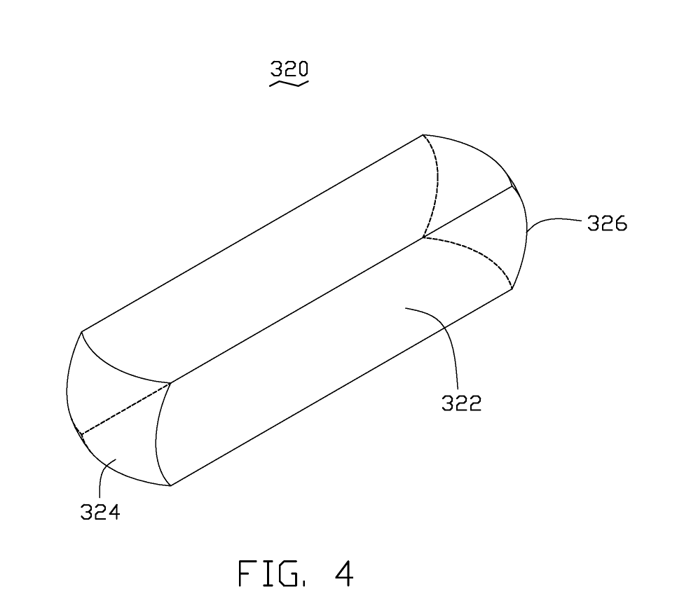

Referring to FIG. 4, a light tunnel 320, according to second preferred embodiment, is an elongated transparent solid body, and includes a sidewall 322, an convex light incident surface 324 for facing toward a light source, and an opposite light emitting surface 326 at an opposite side of the elongated transparent solid body to the light incident surface. The light radiated from a light source enters into the projector light tunnel 320 through the light incident surface 324 and reflected many times by the sidewall 322, finally emitting as an uniform light from the light emitting surface 326 of the projector light tunnel 320.

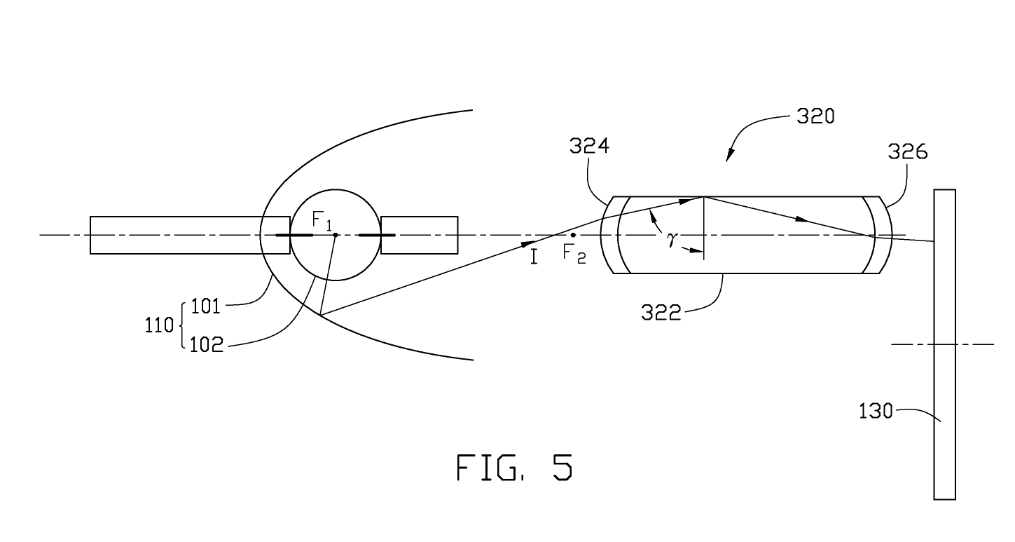

As illustrated in FIG. 5, is an illumination system of a projection apparatus equipped with the projector light tunnel 320. The illumination system includes a light source 100, the projector light tunnel 320 and a filter 130. The light source 100 has an arc lamp 101 and an elliptical reflective mirror 102. The elliptical reflective mirror 102 defines a near focal point F1 and a distant focal point F2.

The projector light tunnel 320 is positioned on the front of the arc lamp 101 and a top center point of the light incident surface 324 is located beyond the distant focal point F2 of the arc lamp 101. The arc lamp 102 radiates light l that is reflected by the elliptical reflective mirror 102 to the projector light tunnel 320. Meanwhile, the angle formed between light l and a center axis of the projector light tunnel 320 becomes small when light l enters into the projector light tunnel 320 via penetrating the convex light incident surface 324 which changes the traveling direction of light l. Accordingly, the incident angle γ of light l entering in the projector light tunnel 320 becomes greater. Therefore the projector light tunnel 320 can receive more effective light than conventional light tunnel 120, because of the convex light incident surface 324 thereof changing the light traveling direction when it passes into the tunnel 220 from air.

The brightness of the center area of light emitted from the projector light tunnel 320 is increased, because the distance light travels between reflections from the sidewall 322 will be increased with the increasing of the incident angle and as a result there is more light at the center axis of the projector light tunnel 320. Understandably, the shape of a cross section of the projector light tunnel may be configured as a square shape for getting a squarely emitting light emitted from the projector light tunnel, in addition the shape of the cross section of the projector light tunnel may be designed as a trapezoid surface, a circular surface or a ellipse surface and so on for getting different shaped emitting light.

Understandably, the light incident surface 324 of the projector light tunnel 320 may be configured as a spherical surface or an aspheric surface for matching the luminosity curve of the light source 100 for receiving more useable light irradiated from the light source. The location of the light incident surface of the projector light tunnel is positioned between the near focal point F1 and the distant focal point F2 or beyond the focal point F2 fully depending on the shape of light incident surface. When the light incident surface is configured as a concave surface which can make the light divergence should be positioned between the near focal point F1 and the distant focal point F2 of the elliptical reflective mirror 102. When the light incident surface is configured as a convex surface which can make the light convergence should be positioned beyond the distant focal point F2 of the elliptical reflective mirror 102.

Understandably, the light emitting surface 326 of the projector light tunnel 320 may be configured as a curved surface corresponding to the light incident surface 324 of the projector light tunnel 320. The light emitting surface 326 of the projector light tunnel 320 is matched to the light incident surface 324 of the projector light tunnel 320 for getting a matched optical characteristics. The projector light tunnel 320 can receive more light reflected from the light filter by the curved light emitting surface 326. The light received by the projector light tunnel 320 can be reflected by the elliptical reflective mirror 102 and be reused to increase the brightness of the light emitting from the projector light tunnel 320.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A projector light tunnel comprising an elongated transparent solid body having a light incident surface for facing toward a light source, a light emitting surface at an opposite side of the elongated transparent solid body to the light incident surface, for uniformly standardizing intensity distribution of light emitted from the light source, the light incident surface being configured as a curved surface.

2. The projector light tunnel as claimed in claim 1, wherein the light incident surface of the projector light tunnel is configured as a spherical surface.

3. The projector light tunnel as claimed in claim 1, wherein the light incident surface of the projector light tunnel is configured as an aspheric surface.

4. The projector light tunnel as claimed in claim 1, wherein the light incident surface of the projector light tunnel is configured as a concave surface.

5. The projector light tunnel as claimed in claim 1, wherein the light incident surface of the projector light tunnel is configured as a convex surface.

6. The projector light tunnel as claimed in claim 1, wherein the light emitting surface of the projector light tunnel is configured as a curved surface.

7. The projector light tunnel as claimed in claim 1, wherein the light emitting surface of the projector light tunnel is configured same as the light incident surface of the projector light tunnel for getting a matched optical characteristics.

8. The projector light tunnel as claimed in claim 1, wherein the light emitting surface of the projector light tunnel is concave.

9. The projector light tunnel as claimed in claim 1, wherein the light emitting surface of the projector light tunnel is convex.

10. The projector light tunnel as claimed in claim 1, wherein a shape of the cross section of the projector light tunnel is selected from the group consisting of square, trapezoid, circular and ellipse.

11. A projector illumination system comprising
a light source, the light source including a lamp and an elliptical reflective mirror, the elliptical reflective mirror defined a near focal point and a distant focal point, the arc lamp positioned on the near focal point,
a light tunnel for uniformly standardizing intensity distribution of light emitted from the light source, the projector light tunnel comprising an elongated transparent solid body having a light incident surface facing toward a light source, a light emitting surface at an opposite side of the elongated transparent solid body to the light incident surface, the light incident surface being configured as a curved surface, a top point on the light incident surface of the projector light tunnel located beyond the near focal point and offsetting from the distant focal point, and a filter.

12. The projector illumination system as claimed in claim 11, wherein the light incident surface of the projector light tunnel is configured as a concave surface, the center of the light incident surface of the projector light tunnel is positioned between the near focal point and the distant focal point of the elliptical reflective mirror.

13. The projector illumination system as claimed in claim 11, wherein the light incident surface of the projector light tunnel is configured as a convex surface, the center of the light incident surface of the projector light tunnel is positioned beyond the distant focal point of the elliptical reflective mirror.
